(19) United States
(12) Patent Application Publication
(10) Pub. No.: US 2020/0191997 A1
(43) Pub. Date: Jun. 18, 2020

(54) GENERATING WEATHER MODELS USING REAL TIME OBSERVATIONS

(71) Applicant: Loon LLC, Mountain View, CA (US)

(72) Inventors: Salvatore J. Candido, Mountain View, CA (US); Sameera Sylvia Ponda, Mountain View, CA (US)

(21) Appl. No.: 16/531,873

(22) Filed: Aug. 5, 2019

Related U.S. Application Data
(60) Provisional application No. 62/781,268, filed on Dec. 18, 2018.

(51) Int. Cl. G01W 1/10; G01W 1/08; G01W 1/02; G01S 13/95; G06N 7/00

(52) U.S. Cl. CPC G01W 1/10; G01W 1/08; G01W 1/02; G01W 2203/00; G01S 13/951; G01S 13/955; G06N 7/005; G01S 13/953

(57) ABSTRACT

The technology relates to generating current and future estimated weather models for predicting current and future estimated weather data. This may include indexing observations including weather data on a first grid based on locations of the observations. The first grid may have a plurality of cells each representing a volume of space for an area of the earth. A second cell of a second grid having a plurality of second cells each representing a volume of space for an area of the earth may be identified. The dimensions of the first cell may be increased. A set of indexed observations may be identified by selecting ones of the set of indexed observations that are indexed to any of the plurality of first cells having geographic areas that at least partially overlap with the increased dimensions. The set of indexed observations may be used to train a model.

### CROSS-REFERENCE TO RELATED APPLICATION

The present application claims the benefit of the filing date of U.S. Provisional Patent Application No. 62/781,268 filed Dec. 18, 2018, the entire disclosure of which is incorporated by reference herein.

### BACKGROUND

Computing devices such as personal computers, laptop computers, tablet computers, cellular phones, and countless types of Internet-capable devices are increasingly prevalent in numerous aspects of modern life. As such, the demand for data connectivity via the Internet, cellular data networks, and other such networks, is growing. However, there are many areas of the world where data connectivity is still unavailable, or if available, is unreliable. Accordingly, additional network infrastructure is desirable.

Some systems may provide network access via a network including a plurality of aircraft, such as balloons, operating in the stratosphere. To maintain the network, each may be required to be located at and/or to travel to a particular location. However, because these balloons rely on current wind conditions to assist in navigation efforts to different locations, it is critical to have as much real time and up to date forecast data as possible. Typically, this forecast data as well as confidence values for the forecast data is retrieved from databases or feeds run by organizations such as the National Oceanic and Atmospheric Administration (NOAA) or the European Centre for Medium-Range Weather Forecasts (ECMWF). However, because the highly-sophisticated models used by these systems take significant amounts of time to update forecasts, there is typically a lag of up to 12 hours between when data is observed and when it is incorporated and published as forecast data. As such, the forecast data is already somewhat stale and may not actually match up with what is observed by the balloon. Put another way, any discrepancy between the observed conditions and forecasted conditions in the aforementioned models may persist for at least the period of time required to generate a new forecast.

In addition, these models do not typically provide accurate wind data for higher altitudes, for instance in the stratosphere. As an example, real time measurements of weather conditions in the stratosphere may be sparse, and a typical error for wind speed in the aforementioned models may be on the order of 4 m/s. Given that average wind speeds are around 5 to 6 m/s in the stratosphere, this error is relatively large and can have a significant effect on the navigation planning for aircraft in the stratosphere.

### BRIEF SUMMARY

Aspects of the present disclosure are advantageous for high altitude balloon systems. For instance, one aspect of the disclosure provides a method for generating current and future estimated weather models for predicting current and future estimated weather data. The method includes receiving, by one or more server computing devices, observations, each received observation including actual weather data for a location; indexing, by the one or more server computing devices, each given received observation to a cell of a first grid based on the location of the given received observations, the first grid having a plurality of first cells each representing a volume of space for a geographic area of the earth; selecting, by the one or more server computing devices, a second cell of a second grid, the second grid having a plurality of second cells each representing a volume of space for an area of the earth, the plurality of second cells being different from the plurality of first cells; increasing, by the one or more server computing devices, dimensions of the second cell; identifying, by the one or more server computing devices, a set of indexed observations by selecting ones of the indexed set of observations that are indexed to any of the plurality of first cells having geographic areas that at least partially overlap with the increased dimensions of the second cell; and using, by the one or more server computing devices, the set of indexed observations to train a model for generating current and future estimated weather data for the second cell, the training producing a set of trained parameter values for the model for the second cell.

In one example, the method also includes receiving location information; retrieving the set of parameter values for the second cell based on the location; and, using the set of parameter values, estimating at least one of current or future weather data for the second cell for a given time into the future. In this example, each observation includes latitude and longitude information as well as a vector representing wind direction and speed, such that the estimated provides estimates for wind direction and speed within the second cell for the given time. In addition or alternatively, each observation of the set of observations includes latitude and longitude information as well as a temperature measurement, such that the estimated weather data provides an estimate for temperature within the second cell for the given time. In addition or alternatively, each observation of the set of observations includes latitude and longitude information as well as a wind vector measurement, such that the estimated weather data provides an estimate for a wind vector within the second cell for the given time. In addition or alternatively, each observation of the set of observations includes latitude and longitude information as well as a humidity measurement, such that the estimated data provides an estimate for humidity within the second cell for the given time. In addition or alternatively, each observation of the set of observations is associated with a pressure measurement, and wherein the predicted current and future estimated weather data provides estimates for pressure within the second cell for the given time. In addition or alternatively, at least one observation of the set of observations includes upwelling infrared flux information such that the estimated data provides an estimate for predicting cloud characteristics. In addition or alternatively, at least one observation of the set of observations includes lightening information such that the estimated data provides an estimate for predicting lightning characteristics. In addition or alternatively, the estimated current and future estimated weather data includes a mean estimated current and future weather for the given time. In addition or alternatively, the estimated data includes a confidence value based on covariance of the model. In another example, the method also includes removing, from the set of observations, indexed observations older than a predetermined amount of time. In another example, the method also includes identifying any first cells of the plurality of first cells having areas that overlap with the increased dimensions of the second cell; using the identified first cells to determine a second set of indexed observations; and identifying the set of indexed observations using the second set of indexed observations and the locations associated with each of the set of indexed observations. In another example, the method also includes, prior to using the set of indexed observations to train the model, compressing the set of indexed observations. In another example, wherein the model is a Gaussian process model. In another example, the dimensions of the second cell are increased a predetermined amount and the method further comprises using a kernel to train the model. In another example, the observations include real time weather data generated by a weather balloon. In another example, at least one observation of the set of observations includes real time weather data generated by a balloon while in the stratosphere. In another example, at least one observation of the set of observations includes real time weather data generated by a ground-based sensor. In another example, at least one observation of the set of observations includes real time weather data generated by a satellite-based sensor. In another example, the method also includes retrieving current weather forecast data, wherein the current weather forecast data is used to train the model. In another example, an average cell size of the first grid is smaller than an average cell size of the second grid. In another example, the method also includes, for additional cells of the second grid: selecting an additional cell of the second grid; increasing dimensions of the additional cell; identifying a second set of indexed observations for the additional cell by selecting ones of the set of indexed observations having locations within the increased dimensions of the additional cell; and using the second set of indexed observations to train the model for generating current and future estimated weather data for the additional cell, the training producing a set of trained parameter values for the model for the additional cell.

### BRIEF DESCRIPTION OF THE DRAWINGS

FIG. 1 is a functional diagram of a system in accordance with aspects of the present disclosure.

FIG. 2 is an example of a balloon in accordance with aspects of the present disclosure.

FIG. 3 is an example of a balloon in flight in accordance with aspects of the disclosure.

FIG. 4 is an example server system in accordance with aspects of the disclosure.

FIG. 5 is an example a flow diagram in accordance with aspects of the disclosure.

FIG. 6 is an example grid in accordance with aspects of the disclosure.

FIG. 7 is an example grid cell and data in accordance with aspects of the disclosure.

FIG. 8 is an example grid and data in accordance with aspects of the disclosure.

FIG. 9 is an example grid and data in accordance with aspects of the disclosure.

FIG. 10 is an example grid and data in accordance with aspects of the disclosure.

### DETAILED DESCRIPTION

### Overview

The present disclosure generally relates to a planning system for planning flights of wind driven or influenced aircraft such as airships, high-altitude balloons, gliders, certain types of airplanes, etc., for instance, of a duration of one or more days. Because these aircraft rely heavily on current localized wind conditions to assist in navigation efforts to different locations, it is nearly impossible to utilize conventional (and often somewhat static) forecasts for planning purposes. It is critical to have as much real time and up to date forecast data as possible. Typically, for conventional weather models, this forecast data as well as confidence values for the forecast data is retrieved from databases or feeds run by organizations such as the National Oceanic and Atmospheric Administration (NOAA) or the European Centre for Medium-Range Weather Forecasts (ECMWF). However, because the highly-sophisticated models used by these systems take significant amounts of time to update forecasts, there is typically a lag of up to 12 hours between when data is observed and when it is incorporated and published as forecast data. As such, the forecast data is already somewhat stale and may not actually match up with what is observed by the balloons.

In addition, these models do not typically provide accurate wind data for higher altitudes, for instance in the stratosphere. As an example, real time measurements of weather conditions in the stratosphere may be sparse, and a typical error for wind speed in the aforementioned models may be on the order of 4 m/s. Given that average wind speeds are around 5 to 6 m/s in the stratosphere, this error is relatively large and can have a significant effect on the navigation planning for aircraft in the stratosphere.

To reduce these forecast errors, a different modeling approach that utilizes real time observations may be used. For instance, a plurality of sources may provide real time observations or observation data. These observations may include one or any combination of, for instance, latitude, longitude, altitude and/or pressure (and/or the relationship between geometric altitude and pressure or the skew between geometric altitude and pressure altitude), temperatures, humidity, wind vector (speed and direction), upwelling infrared flux (which may be used to identify cloud characteristics), turbulence, lightening characteristics (including, for instance, flash density), precipitation, cloud density, top of atmosphere infrared-radiation, ozone content, etc., and time as well as one or more confidence values representing accuracy of all or some of the data in the observation.

The server computing devices may index each observation by assigning the observation to a cell of a first grid corresponding to a volume of space over an area of the earth. As such, the observations may be continuously and asynchronously indexed. The grid may include a plurality of cells representing discrete volumes of space. Alternatively, the grid may include a plurality of cells representing discrete volumes of space and time, for instance, as a four-dimensional grid. Periodically, this indexed data may be processed to generate current and future estimated weather data. The current and future estimated weather data may be generated using a second grid. The second grid may be different from the first grid in that the first grid may have a greater granularity than the second grid, such that the average cell size of the first grid is smaller than the average cell size of the second grid.

A current and future estimated weather model which fuses both forecast data and real time observations may be generated for each cell of the second grid. In other words, the model may be configured to provide estimates for both real time weather data as well as for some period into the future. In order to generate the model, a first cell of the second grid having a first set of dimensions may be identified. The volume of the first cell may be increased. Any cells of the first grid that at least partially overlap with the increased/enlarged first cell of the second grid may be identified. Any observations within the identified cells that also fall within the volume of the enlarged cell may be identified. These observations may be identified based on location data (e.g. latitude, longitude, altitude etc.) included in the observation. The server computing devices may also retrieve any current forecast data, for instance, the aforementioned published forecast data for locations within the first cell.

Using the identified observations within the first cell as well as the retrieved current forecast data, a current and future estimated weather model may be generated for the cell. This may involve processing the identified observations as well as the current forecast data to fit the model. In some instances, the model may be a Gaussian process model that is trained on the observations and the retrieved current forecast data using a kernel. The result of the training may be a set of trained parameter values for the Gaussian process model for the first cell. This process may be repeated for all other cells, or specific cells of interest, of the second grid.

The model for a given cell may be used to provide both current and future estimated weather data as well as confidence or covariance values for the current and future estimated weather data within the given cell. For instance, to determine current and future estimated weather for a given location (e.g. latitude and longitude and altitude), the second grid may be searched to identify a second cell of the second grid in which the given location is. The latitude, longitude, pressure (or altitude or the relationship between geometric altitude and pressure) and time may be input into the model using the set of trained parameter values associated with the second cell in order to generate current and/or future estimated weather data (depending upon the time provided). The current and/or future estimated weather data may be provided to one or more control systems for use in determining a control strategy for, for instance, an aircraft's steering controls or operation of a wind farm. The aircraft's steering controls or the wind farm may then be controlled by the control system on the basis of the control strategy.

To keep the current and future estimated weather data generated by the models consistent and as up to date as possible, in addition to indexing new observations received by the server computing devices, older or stale observations may be deleted, de-indexed, or otherwise ignored. In addition, the aforementioned processing and model training may occur periodically, for all of the cells of the grid. As such, each time the parameter values are used to generate current and future estimated weather data, the weather data provided is as fresh as possible and several hours ahead of that available from the aforementioned conventional weather models. This, in turn, can have significant impact on how an aircraft's steering controls are used.

The features described herein enable fast integration of observed data into current and future estimated weather data including data such as pressure, temperatures, humidity, upwelling infrared flux, wind vector (speed and direction), turbulence, lightening characteristics, precipitation, cloud density, top of atmosphere infrared-radiation, ozone content and various other conditions. Such information may be useful for aircraft (i.e. aviation applications) as well as other areas of technology which require real time forecasting such as wind farms, agricultural farming, precipitation forecasting, etc. The features provide an independent process that collects the latest weather data from each source and can automatically update and/or change the data stored across different storage systems, for instance, data centers. Moreover, because the parametrization of the model for a given cell is separable from the parametrization of models for other cells, this processing can be partitioned across different server computing devices in the same or different data centers in a nearly infinite number of ways. Thus, the model and its generation could be said to be adapted for a specific technical implementation. In addition, other aspects, such as performing indexing operations and responding to queries can also be tasked for completion by a plurality of different server computing devices. In other words, as compared to the aforementioned sophisticated models which may require high throughput and supercomputers to process, the parametrization can be performed with much lower throughput across a plurality of typical server computing devices in a server farm. Moreover, because each cell is expanded to capture observations that are nearby and possibly very relevant (i.e. edge cases where points are just outside of the cell boundary), the models end up slightly overlapping with the data in adjacent cells of the first grid. This makes the sets of trained parameter values more consistent across adjacent grid cells and thereby reduces discontinuity between those cells.

### Example System

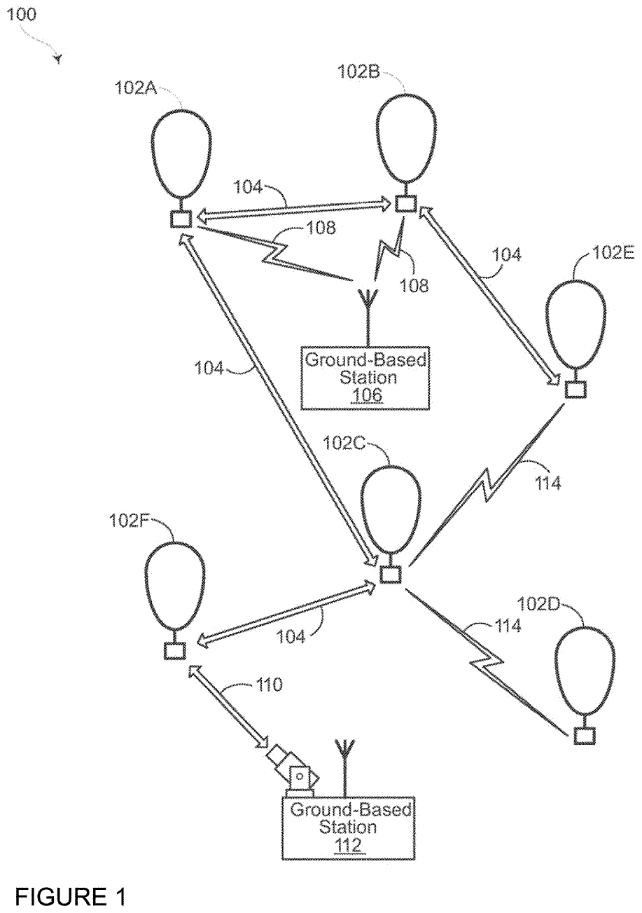

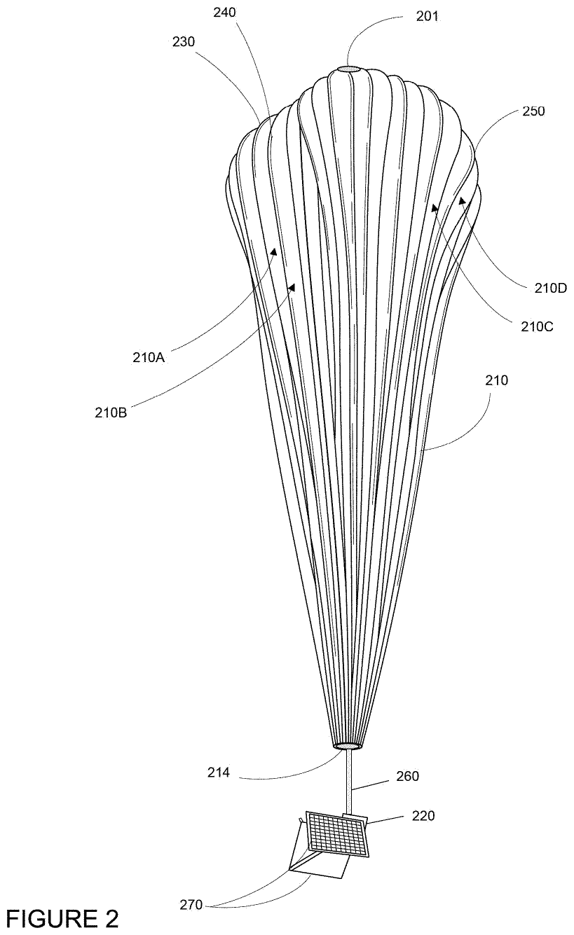

FIG. 1 depicts an example system 100 in which an aircraft as described above may be used. This example should not be considered as limiting the scope of the disclosure or usefulness of the features of the present disclosure. For example, the techniques described herein can be employed for use with various types of aircraft and systems. In this example, system 100 may be considered a “balloon network” though in addition to balloons the network may include high altitude platforms, satellites, manned and unmanned aerial vehicles including wind driven or influenced aircraft such as airships, high-altitude balloons, gliders, certain types of airplanes, etc. As such, the system 100 includes a plurality of devices, such as balloons 102A-F, ground base stations 106 and 112 and links 104, 108, 110 and 114 that are used to facilitate intra-balloon communications as well as communications between the base stations and the balloons. One example of a balloon is discussed in greater detail below with reference to FIG. 2.

### Example Balloon

FIG. 2 is an example balloon 200, which may represent any of the balloons of the system 100. As shown, the balloon 200 includes an envelope 210, a payload 220 and a plurality of tendons 230, 240 and 250 attached to the envelope 210. The balloon envelope 210 may take various forms. In one instance, the balloon envelope 210 may be constructed from materials such as polyethylene that do not hold much load while the balloon 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, hydrogen or any other lighter-than-air gas. The envelope 210 is thus arranged to have an associated upward buoyancy force during deployment of the payload 220.

The payload 220 of balloon 200 may be affixed to the envelope by a connection 260 such as a cable or other rigid structure. The payload 220 may include a computer system (not shown), having one or more processors and on-board data storage (similar to processors 420 and memory 430 described below). The payload 220 may also include various other types of equipment and systems (not shown) to provide a number of different functions. For example, the payload 220 may include various communication systems such as optical and/or RF, a navigation system, a positioning system, a lighting system, an altitude control system (configured to change an altitude of the balloon), a plurality of solar panels 270 for generating power, a power supply (such as one or more batteries) to store and supply power to various components of balloon 200.

In view of the goal of making the balloon envelope 210 as lightweight as possible, it may be comprised of a plurality of envelope lobes or gores that have a thin film, such as polyethylene or polyethylene terephthalate, which is lightweight, yet has suitable strength properties for use as a balloon envelope. In this example, balloon envelope 210 is comprised of envelope gores 210A-210D.

Pressurized lift gas within the balloon envelope 210 may cause a force or load to be applied to the balloon 200. In that regard, the tendons 230, 240, 250 provide strength to the balloon 200 to carry the load created by the pressurized gas within the balloon envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top cap 201 positioned at the apex of balloon envelope 210. A corresponding apparatus, e.g., bottom cap 214, may be disposed at a base or bottom of the balloon envelope 210. The top cap 201 at the apex may be the same size and shape as and bottom cap 214 at the bottom. Both caps include corresponding components for attaching the tendons 230, 240 and 250 to the balloon envelope 210.

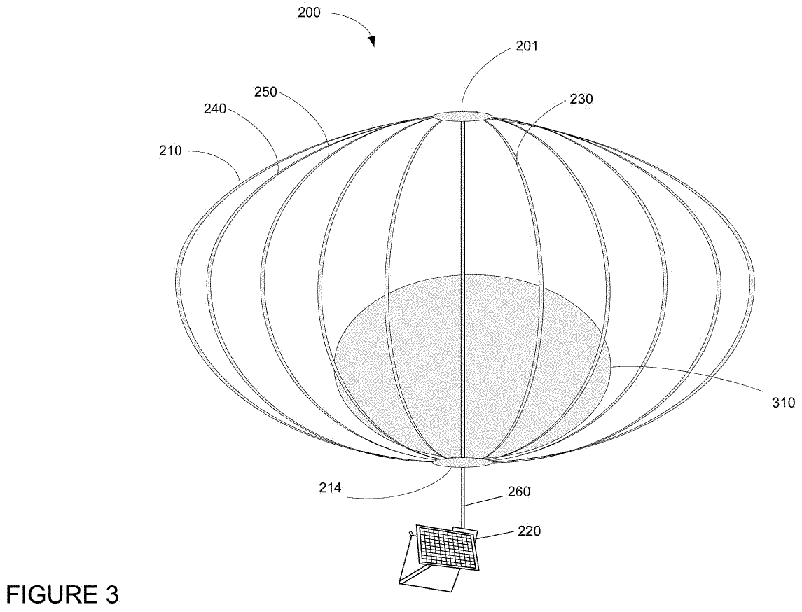

FIG. 3 is an example of balloon 200 in flight. In this example, the shapes and sizes of the balloon envelope 210, connection 260, ballast 310, and payload 220 are exaggerated for clarity and ease of understanding. During flight, these balloons may use changes in altitude to achieve navigational direction changes. For example, the altitude control system of the payload 220 may cause air to be pumped into the ballast 310 within the balloon envelope 210 which increases the mass of the balloon and causes the balloon to descend. Similarly, the altitude control system may cause air to be released from the ballast 310 (and expelled from the balloon) in order to reduce the mass of the balloon and cause the balloon to ascend.

### Example Server System

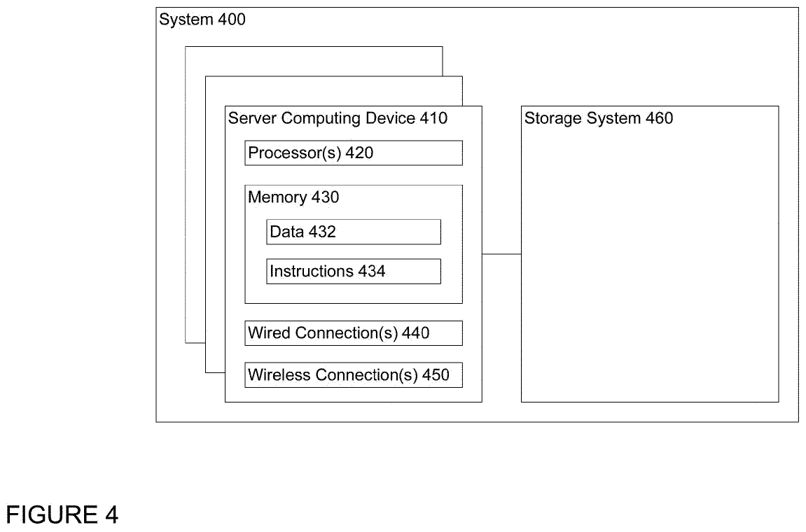

FIG. 4 is an example of a server system 400 which may be, for instance, incorporated into ground base stations 106, 112. As shown, the server system 400 includes one or more server computing devices 410 and a storage system 460 as shown in FIG. 4. For instance, each of ground base stations 106, 112 may be a datacenter including the storage system 460 as well as the server computing devices 410. In this regard, the server computing devices may function as a load balanced server farm in order to exchange information with different nodes of various networks for the purpose of receiving, processing and transmitting the data to and from other computing devices. As such, each of the one or more server computing devices 410 may include one or more processors 420, memory 430 and other components typically present in general purpose computing devices.

The memory 430 stores information accessible by the one or more processors 420, including instructions 434 and data 432 that may be executed or otherwise used by the processor 420. The memory 430 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 434 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 432 may be retrieved, stored or modified by processor 420 in accordance with the instructions 434. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any, given point in time as well as information about the location of network targets.

The one or more processor 420 may be any conventional processors, such as commercially available CPUs or GPUs. Alternatively, the one or more processors may be a dedicated device such as an ASIC, quantum processor, or other hardware-based processor. Although FIG. 4 functionally illustrates the processor, memory, and other elements of computing device 400 as being within the same block, it will be understood by those of ordinary, skill in the art that the processor, computing device, or memory may actually include multiple processors, computing devices, or memories that may or may not be stored within the same physical housing. For example, memory may be a hard drive or other storage media located in a housing different from that of server computing devices 410. Accordingly, references to a processor or computing device will be understood to include references to a collection of processors or computing devices or memories that may or may not operate in parallel.

The server computing devices 410 may also include one or more wired connections 440 and wireless connections 450 to facilitate communication with other devices, such as the storage system 460, one or more information services, and other devices of the network 100. These information services may include, for instance, systems that provide weather predictions from organizations such as the National Oceanic and Atmospheric Administration (NOAA) or the European Centre for Medium-Range Weather Forecasts (ECMWF). The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Storage system 460 may store various types of information, including grids, cells, indexed observations, and sets of trained parameter values as described in more detail below. This information may be retrieved or otherwise accessed by one or more server computing devices, such as the server computing devices 410, in order to perform some or all of the features described herein. As with memory 430, storage system 460 can be of any type of computer storage capable of storing information accessible by the server computing devices 410, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 460 may be connected to the server computing devices 410 directly (i.e. as part of server computing devices 410 and/or via wired connections 440) and/or via a network (i.e. via wired connections 440 and/or wireless connections 450). This network may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

### Example Methods

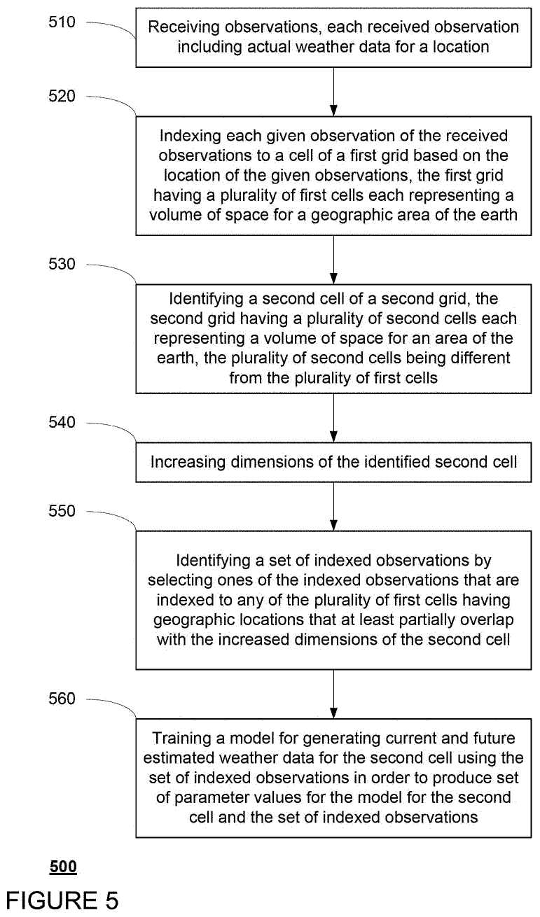

FIG. 5 is an example flow diagram 500 in accordance with aspects of the disclosure which may be performed, for instance, by one or more of the server computing devices 410 including the processors 420, in order to generate current and future estimated weather models for predicting current and future estimated weather data. For instance, at block 510, observations are received. Each received observation includes actual weather data for a location. For instance, a plurality of aircraft, such as balloon 200 and/or other devices of network 100, may provide observations or observation data. These observations may include one or any combination of, for instance, latitude, longitude, altitude and/or pressure, temperatures, humidity, wind vector (speed and direction), upwelling infrared flux, turbulence, lightening characteristics (including, for instance, flash density), precipitation, cloud density, top of atmosphere infrared-radiation, ozone content, etc. as well as time and one or more confidence values representing an accuracy of data in the observation. Each observation may then be sent by the aircraft to (and received by) the server computing devices 410.

In addition to the observations from aircraft, other observations, such as those made using weather balloons, satellites, and/or aircraft including sensors such as radiosondes, LIDAR or SODAR sensors, anemometers, and/or sonar sensors, and other sources of real time weather data including temperature, humidity, and/or wind vectors may be received or retrieved by the server computing devices 410. In addition or alternatively, the aforementioned sensors may be located on the ground or mounted on tall buildings or other structures. Again, each of these observations may also be associated with one or more confidence values.

As shown in block 520, each given received observation is indexed to a cell of a first grid based on the location of the given received observation. The first grid has a plurality of first cells each representing a volume of space for a geographic area of the earth. For instance, the server computing devices 410 may index each observation by assigning the observation to a cell of a first grid corresponding to a volume of space over a geographic area of the earth. Alternatively, the grid may include a plurality of cells representing discrete volumes of space and time, for instance, as a four-dimensional grid. In any event, the set of observations may be continuously and asynchronously indexed as the observations are retrieved or received by the server computing devices 410. Because the earth is a curved surface, the first grid may be arranged such that cells closer to the poles are smaller than cells closer to the equator. For instance, the first grid may include Google LLC's S2 cells, and/or cells configured using a Hilbert curve covering all or some portion of the Earth. For example, a country like Peru may be associated with 10-12 grid cells.

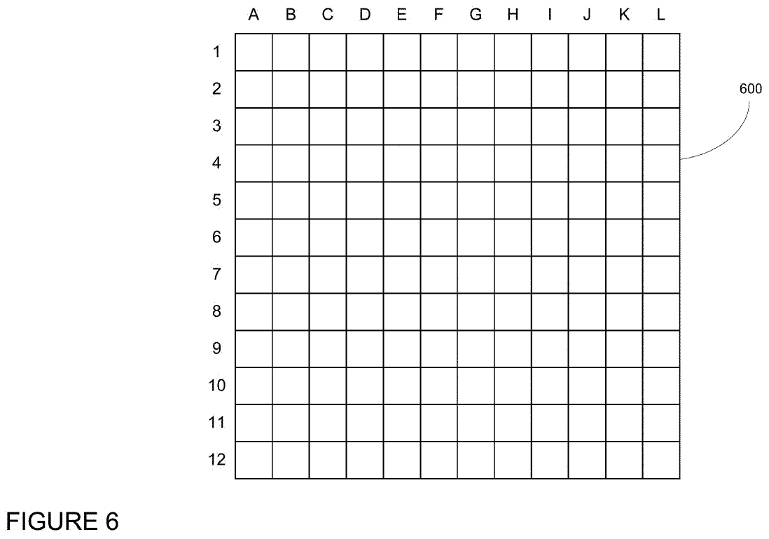

FIG. 6 is an example representation of a first grid 600 including 144 cells. Each cell includes an identifier, here represented by letters A-L and number 1-12. For simplicity, all of the cells are depicted as squares, though as described above, each cell may actually have a slightly different (e.g. curved or diamond) shape corresponding to the S2 cells. In this example, each cell also represents a geographic area of the earth and some volume of space above that geographic area, for instance including all of the areas below the mesosphere, including the stratosphere. However, as noted above, each cell may also represent a discrete period of time.

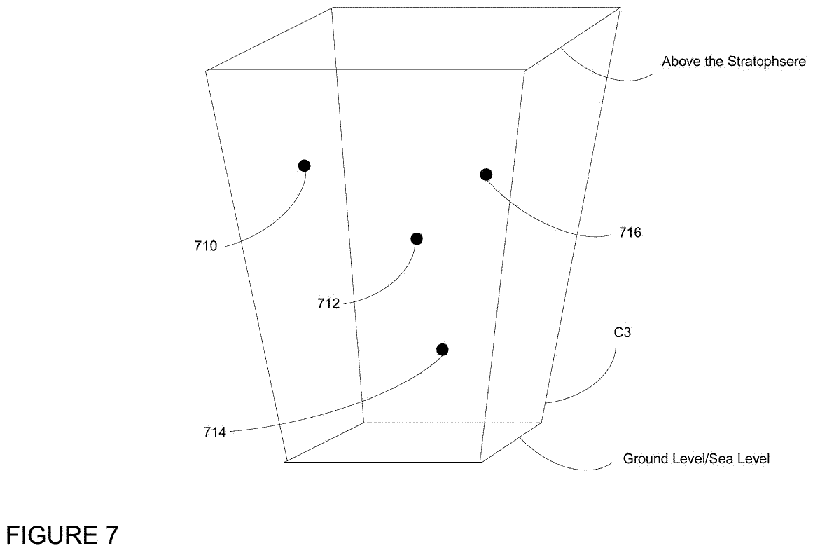

As an observation is received by the server computing devices 410, the latitude and longitude (and in some instances, altitude or pressure) may be used to identify a particular cell. The observation may then be indexed to the identified cell of the grid. FIG. 7 represents a side-perspective view of a single cell, here cell C3. As shown, cell C3 is slightly larger in size at the top (just above the stratosphere) than at the bottom (ground or sea level), again due to the curvature of the earth. In this example, the cell C3 includes a plurality of indexed observations represented by indexed observations 710, 712, 714, and 716. Although not shown, as noted above, each of these indexed observations may include information such as latitude, longitude, altitude and/or pressure (and/or the relationship between geometric altitude and pressure or the skew between geometric altitude and pressure altitude), temperatures, humidity, upwelling infrared flux, wind vector (speed and direction), turbulence, lightening characteristics, precipitation, cloud density, top of atmosphere infrared-radiation, ozone content, and time as well as one or more confidence values representing an accuracy of data in the observation.

For instance, the observations may include sets of x-y pairs: <xᵢ, yᵢ>. For each x-y pair, “x” may refer to the “index” or the location of the observation. As an example, xᵢ may include a latitude component (latᵢ), a longitude component (lonᵢ), a pressure/altitude component (pᵢ), and a time (tᵢ). The “y” may represent the data for the observations. As an example, yᵢ may include a wind vector component for the West to East direction (windᵤᵢ), a wind vector component for the South to North direction (windᵥᵢ), an ambient temperature (tempᵢ), and any other measurements for the observation. Thus, there may be a plurality of indexed observations or <xᵢ, yᵢ> pairs.

Periodically, this indexed data may be processed to generate current and future estimated weather data, or in common parlance, a nowcast and a forecast. This may be done using a second grid. The second grid may have a plurality of second cells each representing a volume of space for a geographic area of the earth. The plurality of cells of the second grid may be different from the plurality of cells of the first grid. Like the first grid, the second grid may include Google LLC's S2 cells and/or cells configured using a Hilbert curve covering all or some portion of the Earth. However, the second grid may be different from the first grid in that the first grid may have a greater granularity than the second grid, such that the average cell size of the first grid is smaller than the average cell size of the second grid. For example, the first grid may use S2 Level 10 cells, and the second grid may use S2 level 7 cells, though different combinations of levels may also be used.

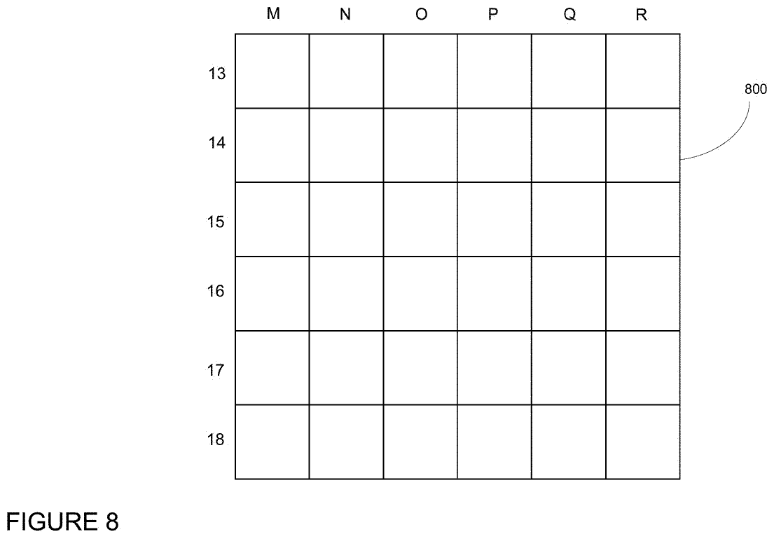

FIG. 8 is an example representation of a second grid 800 including 36 cells representing the same geographical area as the first grid 600. As such, the granularity of grid 600 is greater than that of grid 800, or rather, the average cell size of the first grid is smaller than the average cell size of the second grid. Each cell includes an identifier, here represented by letters M-R and number 13-18. For simplicity, all of the cells are depicted as squares, though as described above, each cell may actually have a slightly different (e.g. curved or diamond) shape corresponding to the S2 cells. Each cell also represents a geographic area of the earth and some volume of space above that geographic area, for instance including all of the areas below the mesosphere, including the stratosphere.

A current and future estimated weather model which fuses both forecast data and real time observations may be generated for each cell of the second grid. In other words, the model may be configured to provide estimates for both real time weather data as well as for some period into the future, such as 12 hours or more or less. Turning to block 530 of FIG. 5, in order to generate the model, a second cell of a second grid is selected or otherwise identified, for instance based on the last time the data indexed to that cell was processed. As an example, grid cell N14 of grid 800 may be selected.

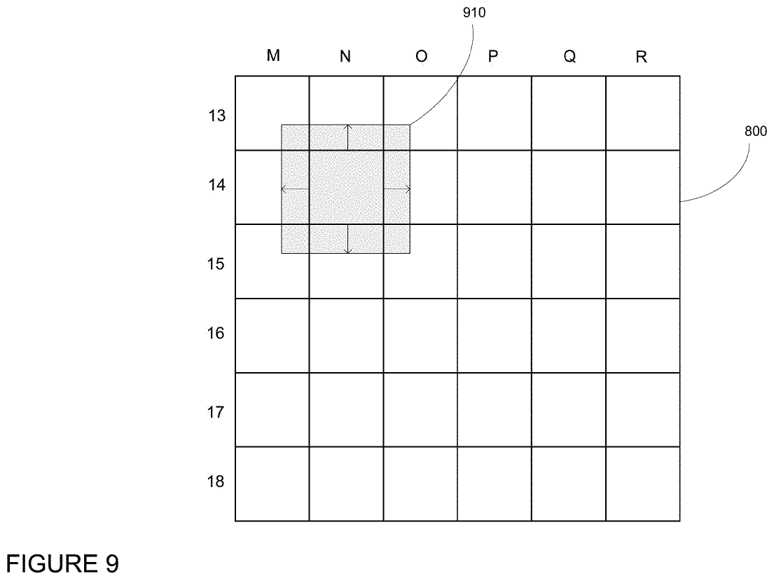

Then, in block 540 of FIG. 5, the dimensions of the selected second cell are increased. For instance, the lateral dimensions of the identified cell N14, for example at ground level, may be increased by a predetermined amount, such as 50 km or more or less. For example, as shown in FIG. 9, the dimensions of cell N14 are increased by increasing the dimensions of cell by 50 kilometers. In this regard, each arrow may represent 25 km. Thus, the area (and volume) represented by the increased cell 910 is larger than the area (and volume) represented by the cell N14.

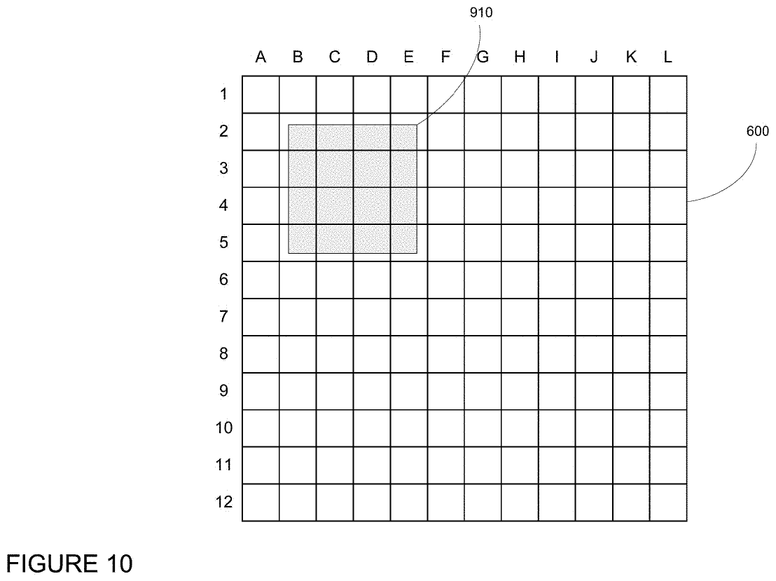

As shown in block 550 of FIG. 5, a set of indexed observations are identified by selecting ones of the indexed observations that are indexed to (or have locations within) any of the plurality of first cells having geographic locations that at least partially overlap with the increased dimensions of the second cell. For instance, any cells of the first grid that at least partially overlap with the increased second cell may be identified. For example, turning to the example of FIG. 10, when shown as overlaid with grid 600, increased cell 900 at least partially overlaps with each of cells B2, B3, B4, B5, C2, C3, C4, C5, D2, D3, D4, D5, E2, E3, E4, and E5. Any observations indexed to the identified cells that also fall within the volume of the increased cell may be identified. In other words, any observations that are indexed to cells B2, B3, B4, B5, C2, C3, C4, C5, D2, D3, D4, D5, E2, E3, E4, and E5 may be identified. For instance, this would include indexed observations 710, 712, 714, and 716 of FIG. 7. This allows the model to incorporate all observations that are close enough (first order approximation) to affect the current and future estimated weather within a cell while also bounding the geographic scope of the indexed data that will be retrieved.

All of the identified indexed observations may then be processed to compress the observations. For instance, some observations may be very similar to other observations for the same cell or rather, duplicative. These duplicative observations thus provide very little useful additional information to the training. As such a data selection algorithm that de-duplicates these types of observations, for instance by assigning a score to each measurement and following a greedy strategy to maximize overall score may be used. These algorithms may reflect the observations data or differences relative to other observations for the cell.

Turning to block 560 of FIG. 5, the first set of indexed observations are used to train a model for generating current and future estimated weather data for the second cell, the training producing a set of trained parameter values for the model for the second cell. In order to do so, the server computing devices may also retrieve any current forecast data, for instance, the aforementioned published forecast data for locations within the first cell. This data may be retrieved as needed and/or stored for short periods of time, indexed to the first grid.

Using the identified observations (including confidences) within the first cell as well as the retrieved current forecast data (and associated confidence values), a current and future estimated weather model may be generated for the cell. This may involve processing the identified observations as well as the current forecast data to fit the model. In some instances, the model may be a Gaussian process model that is trained on the observations and the retrieved current forecast data using a kernel. The kernel may be tuned based on the predetermined amount that the first grid is expanded (e.g. observations beyond 50 km from the first cell would not affect the parametrization of the Gaussian process model). This predetermined amount and/or the general form of the kernel may be determined based on observations from historical flight data. The kernel may then be adapted based on the current observations and forecast data. This may thus occur every time a new model is generated. As such, the set of trained parameter values may vary from cell to cell.

In one instance, the kernel may include a squared-exponential kernel function. In this regard, the kernel may include components that represent distances from point to point in latitude, longitude, pressure and time. This may allow for the kernel to control how much each observation is valued or how much each observation influences the model for a given cell. As an example, the kernel may allow for control of how much an observation that is 200 Pa away in pressure or an observation that is 1.5 degrees away in latitude is valued. As such, the influence that each observation has on the model may be based on “hyper-parameters” tuned on a periodic basis using an adaptive algorithm that attempts to learn the parameters for each model that minimize estimation error as much as possible.

As an example, in order to generate a model for a given cell, the <xᵢ, yᵢ> pairs of the first set of indexed observations may be used to train a Gaussian process model. The Gaussian process model may provide the ability to predict or estimate the values of “y” at some new location/index “m”. In this regard, xₘ may include a latitude component (latₘ), longitude component (lonₘ), a pressure/altitude component (pₘ), and a time component (tₘ) for the index “m”. The Gaussian process model may be used to provide the corresponding y values or yₘ. For instance, ym may include a wind vector component for the West to East direction (windᵤₘ), a wind vector component for the South to North direction (windᵥₘ), an ambient temperature (tempₘ), and any other estimates to be generated by the Gaussian process model.

The Gaussian process model may be represented by the following equation:

μ(yₘ)=K(xₘ,X)[K(X,X)+sigₙ²I]⁽⁻¹⁾Y

Here μ(yₘ) may represent the expected value(s) (or mean) of the estimate for yₘ, K may be a kernel matrix, as noted above, xₘ may be the index for the data to be estimated (or rather, the “location” of yₘ, X may be a set of all the indices (or locations) of all the observations. In this regard, X={x₁, x₂, x₃, . . . , x_{N}}, where N may be the number of <x, y> pairs in the first set of observations. Y may be a set of all the corresponding observations at those index points or Y={y₁, y₂, y₃, . . . , y_{N}}. The value sigₙ² may represent “noise” of the observations and may be used to make sure the kernel matrix K is invertible. The value I may represent an identity matrix, with 1's on the diagonal, 0's everywhere else in the matrix. In this regard, by adding sigₙ², this value is added to the diagonal of the kernel matrix K.

The kernel matrix K in the above equation may be a kernel matrix made by computing the kernel function for pairs of indices, for example, <xᵢ, xⱼ> pairs. For instance, k(xᵢ, xⱼ) may be a kernel function that relates two index points xᵢ and xⱼ to each other. Thus, k may return a number that indicates how strong the relationship between xᵢ and xⱼ is. So K(xₘ, X) may be expressed as:

K(xm,X)=[k(xₘx₁),k(xₘ,x₂),k(xₘ,x₃), . . . ,k(xₘ,x_{N})]

In this example, K(xₘ, X) may be a 1×N matrix. And, K(X, X) may be expressed as:

$$K ( X , X ) = \\ [ k ( {x}_{1} , {x}_{1} ) , k ( {x}_{1} , {x}_{2} ) , k ( {x}_{1} , {x}_{3} ) , … , k ( {x}_{1} , {x}_{N} ) \\ k ( {x}_{2} , {x}_{1} ) , k ( {x}_{2} , {x}_{2} ) , k ( {x}_{2} , {x}_{3} ) , … , k ( {x}_{2} , {x}_{N} ) ; \\ k ( {x}_{3} , {x}_{1} ) , k ( {x}_{3} , {x}_{2} ) , k ( {x}_{3} , {x}_{3} ) , … , k ( {x}_{3} , {x}_{N} ) ; \\ . \\ . \\ . \\ k ( xN , {x}_{1} ) , k ( {x}_{N} , {x}_{2} ) , k ( {x}_{N} , {x}_{3} ) , … , k ( {x}_{N} , {x}_{N} ) ]$$

In this example, K(X, X) may be an N×N matrix.

In order compute the kernel function for the pairs of indices (e.g. k(xᵢ, xⱼ), a squared-exponential kernel may be used:

k(xᵢ,xⱼ)=sig_{f}²*exp(−(R))

In this example, sig_{f}² may be a scaling constant which can affect the absolute valuation of the covariance. R may represent the “distance” between the two index points xᵢ and xⱼ, and may be represented by the equation:

R=[((latᵢ−latⱼ)/wₗₐₜ)²+((lonᵢ−lonⱼ)wₗₒₙ)²+((pᵢ−pⱼ)/wₚ)²+((tᵢ−tⱼ)/wₜ)²]

As with xᵢ, xⱼ may include a latitude component (latⱼ), a longitude component (lonⱼ), a pressure/altitude component (pⱼ), and a time (tⱼ). The wₗₐₜ, wₗₒₙ, wₚ and wₜ may each represent weights or parameters for latitude, longitude, altitude/pressure and time. These parameters may be considered hyper-parameters and may control the amount of influence nearby points (or observations) should have in their respective dimension. For example, if wₗₐₜ is very big, then for the same distance (latᵢ−latⱼ), the computation of R will be smaller, which means that k(xᵢ, xⱼ) will be bigger. That means that for large wₗₐₜ values, points that are far away still have an “influence” on the estimate of yₘ. In contrast, if wₗₐₜ is small, then only points that are nearby in latitude to “m” will be included in it's estimation, and k(xᵢ, xₘ) will be close to 0 for all far away points. The hyper-parameters offer fine control in each dimension, and may be learned during the training process. This can be done in many ways, including for example, leave-one-out cross-validation, where some data is left out, and the rest is used to compute lots of Gaussian process models with different values of hyper-parameters, and then the left out data is used to test which Gaussian process models produces the lowest estimation error.

In order to determine the covariance for ym or cov(yₘ), the following equation may be used:

cov(yₘ)=K(xₘ,xₘ)−K(xₘ,X)[K(X,X)+sig_{f}²I]⁽⁻¹⁾K(X,xₘ)

In this example, K(xₘ, xₘ) may be a 1×1 matrix with just 1 element, K(xₘ, xₘ)=[k(xₘ, xₘ)] which may represents a weight of the index point “m” against itself. The kernel matrix K(X, xₘ) may be expressed as:

$$\begin{matrix}K ( X , {x}_{m} ) = \\ [ k ( {x}_{1} , {x}_{m} ) ; \\ k ( {x}_{2} , {x}_{m} ) ; \\ k ( {x}_{3} , {x}_{m} ) ; \\ ⋮ \\ k ( {x}_{N} , {x}_{m} ) ]\end{matrix}$$

K(X, xₘ) may thus be an a N×1 matrix which is the transpose of K(xₘ, X) if the kernel function is symmetric so k(x₁, xₘ)=k(xₘ, x₁), etc.

The result of the training may be a set of trained parameter values for the Gaussian process model for the first cell. For instance, for each cell, the set of trained parameter values may include wₗₐₜ, wₗₒₙ, wₚ and wₜ as determined for the observations identified in the first set of indexed observations for that cell (or rather, the enlarged cell for that cell). Alternatively, other modeling approaches, such as a neural network, decision tree, running a small physics-based weather model, and/or a combination or hybridization of one or more of these both across and within cells, may be trained using the same data to determine sets of trained parameter values for the machine learning models.

The set of trained parameter values may be associated with the identified second cell. For instance, the set of trained parameter values determined using any observations that are indexed to cells B2, B3, B4, B5, C2, C3, C4, C5, D2, D3, D4, D5, E2, E3, E4, and E5 may be associated with cell N14 of grid 800. This process may be repeated for all other cells, or specific cells of interest, of the second grid.

The model may then be used to provide both current and future estimated weather data as well as confidence or covariance values for the current and future estimated weather data. For instance, when a request for weather data is received at any particular point in time, the server computing devices need only to load the model and the most recent model parameter values for a cell or cells of interest and generate the current and future estimated weather data. This allow the system to provide responses to these requests quickly and efficiently. This can be especially important when the weather data is being used to make real time path planning and other decisions. In addition or alternatively, the model and set of trained parameter values themselves may be provided in response to a request (rather than the output) in order to allow the system that made the request to use the model directly.

For instance, the server computing devices 410 may receive a request for a given location from one or more other computing devices, such as another server computing device or a computing device of an aircraft, such as balloon 200. This given location may include, for example, a latitude and longitude corresponding to a current or last reported location of an aircraft, such as balloon 200. In some instances, the given location may also include a pressure (i.e. an ambient pressure at the balloon envelope that corresponds to an altitude) or altitude. In order to determine current and future estimated weather for the given location, the second grid may be searched to identify a second cell of the second grid in which the given location is. The set of trained parameter values for the identified second cell may then be retrieved. For instance, if the location corresponds to cell N14, the set of trained parameter values associated with the cell N14 may be retrieved.

In order to use the model, the server computing devices 410 may input the latitude, longitude, pressure (or altitude or the relationship between geometric altitude and pressure) and time into the model using the set of trained parameter values associated with the second cell in order to generate current and/or future estimated weather data (depending upon the time provided). This current and/or future estimated weather data may include, for instance, pressures, temperatures, humidity, upwelling infrared flux, wind vector, turbulence, lightening characteristics, precipitation, cloud density, top of atmosphere infrared-radiation, ozone content for the given time input into the model. In addition or alternatively, the current and future estimated weather data may include a mean current and/or future estimated weather for the given time and a confidence value based on the covariance of the model for the second cell.

In some instances, to ensure consistent and continuous availability of the current and future estimated weather data, the system may be implemented with built-in redundancies. For instance, three or more (or less) copies of the system, including the indexing grid, the second grid, and the models, may be running in different server computing devices. In this regard, requests may be distributed to the server computing devices of the different copies in order to balance the load of requests. If any one of those copies fails or otherwise becomes unavailable, there are other server computing devices still able to support and respond to the aforementioned requests. However, in order to implement such a system, as new observations are received, each of the indexing grids of the different copies must be updated to be consistent with one another. In this regard, logic may be implemented to ensure that if the same request is made in duplicate at or near the same time, the same answer should be provided each time.

Depending upon the number of observations for different pressures (altitudes) of a given cell, in some instances, different parameter values may be generated for different pressures. In this regard, for a given pressure value or range of pressure values, only observations within a certain range of pressures (or altitudes) may be used to train the model. As such, when a request is made, in addition to providing location, the request may also identify pressure (or altitude or the relationship between geometric altitude and pressure), In response, the parameter values for the identified pressure for the cell corresponding to the location may be retrieved and used to generate the current and/or future estimated weather.

To keep the current and future estimated weather data generated by the models consistent and as up to date as possible, in addition to indexing new observations received by the server computing devices, older or stale observations may be deleted, de-indexed, or otherwise ignored. For instance, each time new observations are indexed, any observations older than a predetermined amount may be deleted. For example, observations older than 12 hours may be deleted. This allows for the bounding of the temporal scope of the indexed data that will be retrieved. As such, the current and future estimated weather data generated by the models will be at least as timely as the published forecast data.

In addition, the aforementioned processing and model training may occur periodically, for all of the cells of the grid. As an example, all of the cells may be processed, every 1 to 3 minutes or more or less, in any particular order. In this regard, the models for all of the cells are frequently regenerated and/or updated and new observations may be incorporated into one or more models every few minutes rather than every few hours. In some instances, the integration may take place as soon as a few seconds, whereas for the aforementioned conventional weather models, this may take up to 12 hours or more. As such, each time the parameter values are used to generate current and future estimated weather data, the weather data provided is as fresh as possible and several hours ahead of that available from the aforementioned conventional weather models. This, in turn, can have significant impact on how an aircraft's (such as a balloon) steering controls are used.

While the examples described above relate to using real time observations to generate current and future estimated weather data, this modeling may also be performed using historical data. For instance, rather than deleting older observations, this data may be maintained, for instance, in both cases where the first grid is indexed by volumes of space and wherein the first grid is indexed by volumes of space and periods of time. In this regard, these older observations may be used to make better models for past weather conditions. Again, as noted above, this can be especially useful for determining the predetermined amount as well as the configuration of the kernel. As another example, this information may be used to perform an analysis of a best estimate of wind variability historically. For instance, one of the models used by the aforementioned organizations could be fused with observations recorded at different times and then this fused model could be used to evaluate historical variability.

The features described herein enable fast integration of observed data into current and future estimated weather data including data such as pressure, temperatures, humidity, upwelling infrared flux, wind vector (speed and direction), turbulence, lightening characteristics, precipitation, cloud density, top of atmosphere infrared-radiation, ozone content, and various other conditions. Such information may be useful for aircraft (i.e. aviation applications) as well as other areas of technology which require real time forecasting such as wind farms, agricultural farming, precipitation forecasting, etc. The features provide an independent process that collects the latest weather data from each source and can automatically change it across different storage systems, for instance, data centers. Moreover, because the parametrization of the model for a given cell is separable from the parametrization of models for other cells, this processing can be partitioned across different server computing devices in the same or different data centers in a nearly infinite number of ways. Thus, the model and its generation could be said to be adapted for a specific technical implementation. In addition, other aspects, such as performing indexing operations and responding to queries can also be tasked for completion by a plurality of different server computing devices. In other words, as compared to the aforementioned sophisticated models which may require high throughput and supercomputers to process, the parametrization can be performed with much lower throughput across a plurality of typical server computing devices in a server farm. Moreover, because each cell is expanded to capture observations that are nearby and possibly very relevant (i.e. edge cases where points are just outside of the cell boundary), the models end up slightly overlapping with the data in adjacent cells of the first grid. This makes the sets of trained parameter values more consistent across adjacent grid cells and thereby reduces discontinuity between those cells.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for generating current and future estimated weather models for predicting current and future estimated weather data, the method comprising:
receiving, by one or more server computing devices, observations, each received observation including actual weather data for a location;
indexing, by the one or more server computing devices, each given received observation to a cell of a first grid based on the location of the given received observations, the first grid having a plurality of first cells each representing a volume of space for a geographic area of the earth;
selecting, by the one or more server computing devices, a second cell of a second grid, the second grid having a plurality of second cells each representing a volume of space for an area of the earth, the plurality of second cells being different from the plurality of first cells;
increasing, by the one or more server computing devices, dimensions of the second cell;
identifying, by the one or more server computing devices, a set of indexed observations by selecting ones of the indexed set of observations that are indexed to any of the plurality of first cells having geographic areas that at least partially overlap with the increased dimensions of the second cell; and
using, by the one or more server computing devices, the set of indexed observations to train a model for generating current and future estimated weather data for the second cell, the training producing a set of trained parameter values for the model for the second cell.

2. The method of claim 1, further comprising:
receiving location information;
retrieving the set of parameter values for the second cell based on the location; and
estimating at least one of current or future weather data for the second cell for a given time into the future.

3. The method of claim 2, further comprising providing the current or future weather data estimated for the second cell for the given time in the future to a control system of an aircraft for use in determining a steering control strategy for the aircraft.

4. The method of claim 2, wherein each observation includes latitude and longitude information as well as a vector representing wind direction and speed, such that the estimated weather data provides estimates for wind direction and speed within the second cell.

5. The method of claim 2, wherein each observation of the set of observations includes latitude and longitude information as well as a temperature measurement, such that the estimated weather data provides an estimate for temperature within the second cell.

6. The method of claim 2, wherein each observation of the set of observations includes latitude and longitude information as well as a wind vector measurement, such that the estimated weather data provides an estimate for a wind vector within the second cell.

7. The method of claim 2, wherein each observation of the set of observations includes latitude and longitude information as well as a humidity measurement, such that the estimated weather data provides an estimate for humidity within the second cell.

8. The method of claim 2, wherein each observation of the set of observations is associated with a pressure measurement, and wherein the estimated weather data provides estimates for pressure within the second cell.

9. The method of claim 2, wherein at least one observation of the set of observations includes upwelling infrared flux information such that the estimated weather data provides an estimate for predicting cloud characteristics.

10. The method of claim 2, wherein at least one observation of the set of observations includes lightning information such that the estimated weather data provides an estimate for predicting lightning characteristics.

11. The method of claim 2, wherein the estimated weather data includes a mean estimated current and future weather.

12. The method of claim 2, wherein the estimated weather data includes a confidence value based on covariance of the model.

13. The method of claim 1, further comprising, removing, from the set of observations, indexed observations older than a predetermined amount of time.

14. The method of claim 1, further comprising:
identifying any first cells of the plurality of first cells having areas that overlap with the increased dimensions of the second cell;
using the identified first cells to determine a second set of indexed observations; and
identifying the set of indexed observations using the second set of indexed observations and the locations associated with each of the set of indexed observations.

15. The method of claim 1, further comprising, prior to using the set of indexed observations to train the model, compressing the set of indexed observations.

16. The method of claim 1, wherein the model is a Gaussian process.

17. The method of claim 1, wherein the dimensions of the second cell are increased a predetermined amount and the method further comprises using a kernel to train the model.

18. The method of claim 1, wherein the observations include real time weather data generated by a weather balloon.

19. The method of claim 1, wherein at least one observation of the set of observations includes real time weather data generated by a balloon while in the stratosphere.

20. The method of claim 1, wherein at least one observation of the set of observations includes real time weather data generated by a ground-based sensor.

21. The method of claim 1, wherein at least one observation of the set of observations includes real time weather data generated by a satellite-based sensor.

22. The method of claim 1, further comprising retrieving current weather forecast data, wherein the current weather forecast data is used to train the model.

23. The method of claim 1, wherein an average cell size of the first grid is smaller than an average cell size of the second grid.

24. The method of claim 1, further comprising, for additional cells of the second grid:
selecting an additional cell of the second grid;
increasing dimensions of the additional cell;
identifying a second set of indexed observations for the additional cell by selecting ones of the set of indexed observations having locations within the increased dimensions of the additional cell; and
using the second set of indexed observations to train the model for generating current and future estimated weather data for the additional cell, the training producing a set of trained parameter values for the model for the additional cell.
